(19) United States
(12) Patent Application Publication
(10) Pub. No.: US 2018/0064143 A1
(43) Pub. Date: Mar. 8, 2018

(54) Modified atmosphere packaging of Perishable Produce

(71) Applicant: LaserSharp FlexPak Services, LLC, St. Paul, MN (US)

(72) Inventor: Kenneth Klann, Vadnais Heights, MN (US)

(21) Appl. No.: 15/441,100

(22) Filed: Feb. 23, 2017

Related U.S. Application Data
(60) Provisional application No. 62/384,562, filed on Sep. 7, 2016.

(51) Int. Cl. A23L 3/00; A23B 7/00; B65D 65/38; B65D 81/26; B23K 26/382; B23K 26/402

(52) U.S. Cl. CPC A23L 3/00; A23B 7/00; B65D 65/38; B65D 81/268; B23K 2203/42; B23K 26/382; B23K 26/402; A23V 2002/00; B65D 81/263

(57) ABSTRACT

An optimized package for holding a perishable produce that balances between optimum aerobic and anaerobic conditions. The package has a body, formed of a package film having a first size and shape, formed with laser micro perforations formed according to a relationship between a shelf life of said first contents in said package for different oxygen transfer rates expressed as volume of oxygen per time period per package per atmosphere. This is set to optimize between anaerobic conditions and aerobic conditions. There are a number and size of micro perforations, to obtain an optimum oxygen transfer rate. The micro perforations can be formed in a location of the package which retains airflow through the micro perforations when multiple of said packages are stacked. There can also be a humidity reduction device, which can be a valve, or a vapor transmitting film, or a hydroscopic salt on the exterior of the film.

This application claims priority from provisional application No. 62/384,562, filed Sep. 7, 2016, the entire contents of which are herewith incorporated by reference.

### BACKGROUND

The current method of packaging perishable produce, such as Strawberries, Blueberries and Cucumbers, is typified by the use of flexible packaging or semi rigid containers that have macro perforations. A macro perforation is a hole or slot cut into the packaging material forming the package, which ranges in size from roughly ⅛″ to ⅜″. The holes are sized to allow air exchange in a way that is intended to regulate humidity.

Excess moisture in the package can lead to mold conditions.

### SUMMARY

The inventor recognizes optimizing the atmosphere within a sealed package of produce though the laser micro perforation of the packaging film can extend the shelf life of the produce well beyond that expected in current or standard packaging. An optimization of oxygen influx though the micro perforations balanced against the produce's respiration rate is carried out to find a balance between anaerobic conditions and aerobic respiration rates that cause excess moisture.

Air exchange to the package is used to remove the excess moisture in the package, since it was noted that the excess moisture can otherwise lead to mold conditions. However, the inventor found that too much air flow into the package, e.g., air flow meant to remove excess moisture, allows the produce to respire at higher levels. This respiration can also lead to spoilage.

The present application describes techniques to optimize this packaging of produce.

### BRIEF DESCRIPTION OF THE DRAWINGS

in the drawings:

FIG. 1 shows a graphical relationship between OTR and shelf life;

FIG. 2A-2D show a package design;

FIG. 3 shows OTR measurement;

FIG. 4 shows a flowchart of converging low OTR and high OTR;

FIGS. 5A-5B show a humidity reduction device;

FIGS. 6A1, 6A2 and 6B show pulsing oxygen production to the package.

### DETAILED DESCRIPTION

The inventor found that the holes on conventional packages do not control the atmosphere in the package optimally. Conventional packages have used large perforations in the package, e.g., macro perforations that have allowed an abundance of available oxygen inside the package. This oxygen abundance allows the produce inside the package to continue respiration unimpeded. The unimpeded respiration generates an excess of water vapor that eventually condenses and gives rise to mold growth as well as burn the produce's energy reserves. This is because the inventor found that too much air flow, even though intended to remove the humidity, actually causes respiration of the produce in the package adding to even more water.

Techniques to determine the numbers and sizes of perforations, preferably micro perforations, are disclosed for three different kinds of produce (strawberries, Blueberries, and Cucumbers). However, techniques are also described herein for setting the numbers and sizes of the perforations for other produce.

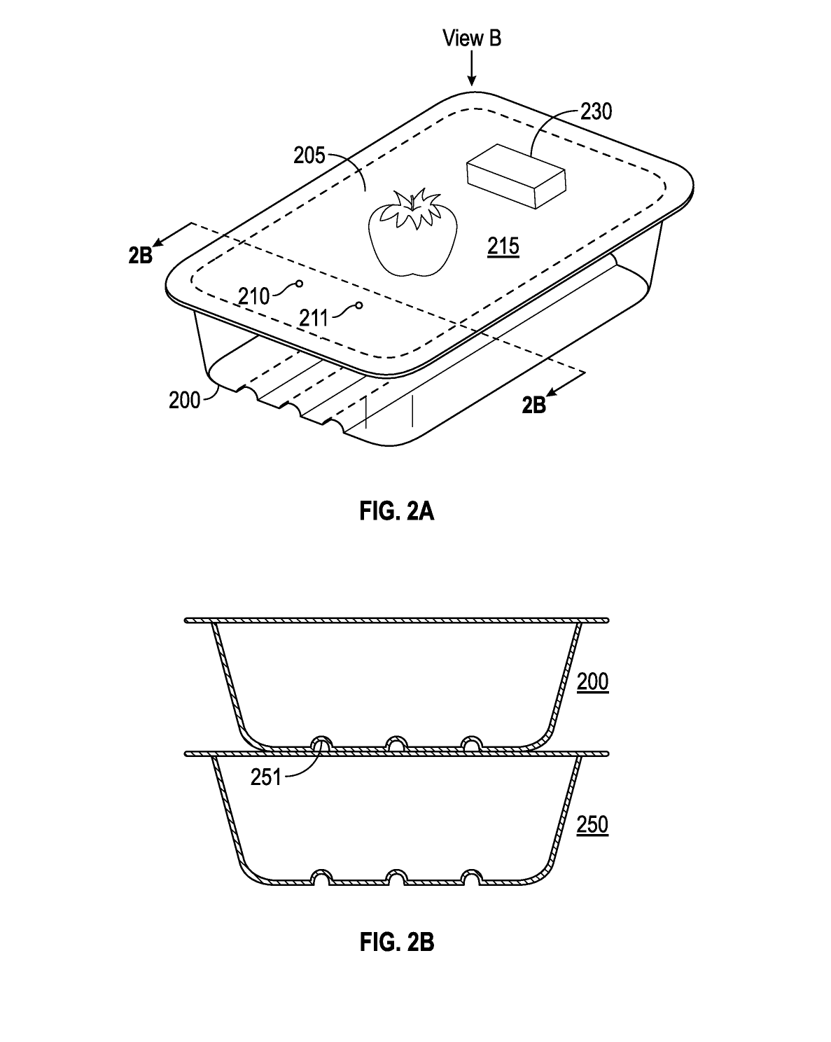

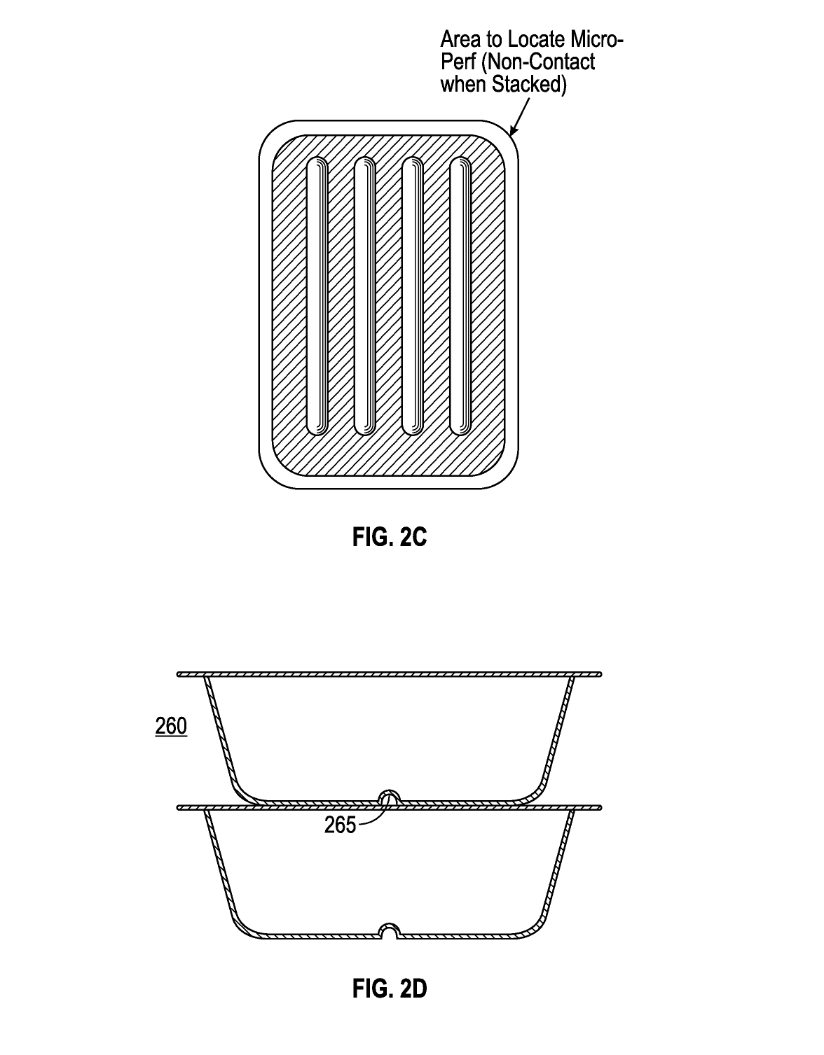

FIGS. 2A and 2B show an exemplary package using the perforations and techniques determined according to the present application. In FIG. 2A, the package 200 has a sealing portion 205 formed of a plastic material, typically a clear plastic material so that the produce 215 inside can be seen. The sealing material includes a plurality of perforations shown as 210, 211; however more or other perforations can also be included. In an embodiment, these perforations are micro perforations.

The amount of oxygen that a micro perforation allows into a package is determined by the number of perforations, size of the perforation(s) and the relative concentration of oxygen inside and outside of the package. The amount of oxygen allowed into the package is referred to herein as the Oxygen Transmission Rate (OTR).

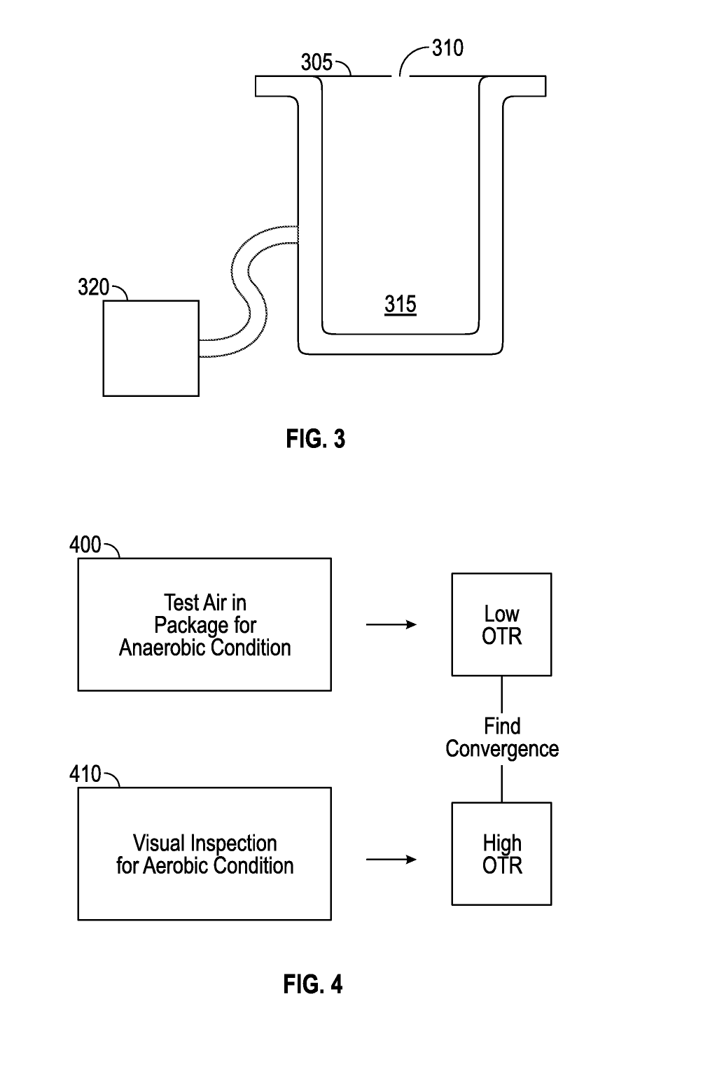

Measurement of this amount of oxygen is carried out by isolating a perforation and measuring the rate of increase of oxygen level in a sealed vessel though that perforation. FIG. 3 shows a test set where a sealed vessel 300 is covered with a top 305 formed of packaging film that has a single perforation 310 therein. The inside 315 of the sealed vessel 300 is then measured with an OTR measurement system 320 such as the Oxysense permeation/OTR system available from Oxysense Inc. Given the concentration of oxygen outside and inside the vessel of known volume at different points in time, the rate of transmission can be calculated.

The relationship of the rate of transmission to the size of the perforation is nearly linear within the range that was found by the inventor to be practical with a laser drilling technique, namely 50 to 150 um. This relationship is based on a 100 um diameter orifice equated to an OTR of 150 cc/day/atmosphere and has a linear slope of 2 cc/day/atm per additional 1 um in diameter.

Samples of three different kinds of produce 316 (strawberries, Blueberries, and Cucumbers) were prepared to test increasing levels of OTR in different configurations; including no perforations (near zero OTR), micro perforations and macro perforations (near infinite OTR). Micro perforations are defined as holes cut thru the film via drilling and are normally in size of 50-600 microns in diameter, Macro perforations are defined as hole(s) cut thru the film via vector and are normally in a range of 600 microns to 6 mm in diameter.

Systems of the present invention are usable with either micro perforations or macro perforations. However, a preferred embodiment uses a micro perforation between 50 and 600 μm, and more preferably between 100 and 150 μm.

FIG. 4 illustrates the testing technique used according to an embodiment.

To determine if the available oxygen is too low and causing anaerobic respiration to occur, either or both of two sampling techniques can be employed to sample for an anaerobic condition at 400. The first technique tests the air within the package with a common alcohol detector. The detector can be located over a small hole in the packaging film. The package is then compressed, exhausting internal air onto the actively sensing probe. The pin hole is sealed after the sample is taken. A reading is recorded, with a positive reading indicating anaerobic conditions as evidenced by the presence of alcohol. In that case, the package's OTR design is concluded to be too restrictive. The most restrictive packages became anaerobic first and less restrictive OTR package later.

An alternative detection of an anaerobic condition can also be determined by an odor of the air within the package. Off odors, stale or musty, are indicators of anaerobic conditions. Either or both indicators would determine end of shelf life. This can be done using manual smell or using an electronic nose.

The condition of too high of an OTR design leading to an aerobic condition is determined visually by inspecting for mold at 410. Higher respiration rates, caused by excess of oxygen, generate water vapor faster than the produce can reabsorb. The subsequent condensation on the produce's surface is available to microbiological growth, typically mold. The appearance of mold determines the end of shelf life. Visual means of detecting mold include direct observation and time lapse photography. In one embodiment, a sample is being observed with relative ease and end of shelf life could be correlated with a time stamp of the compiled video.

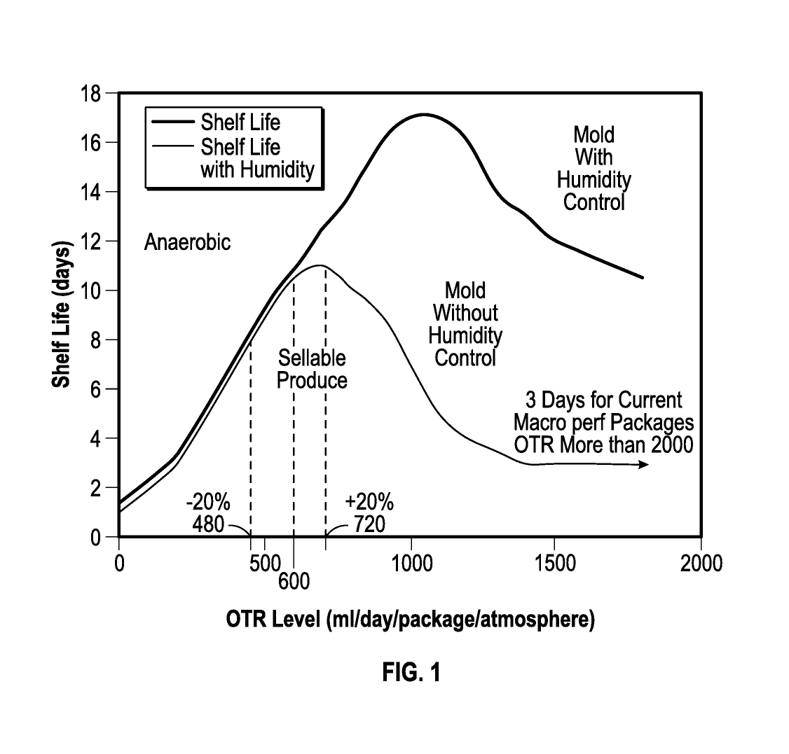

The two limiting factors of shelf life: on the one hand too small OTR leading to anaerobic conditions, and on the other hand, too high OTR leading to aerobic respiration can be graphed as shown in FIG. 1. The longest time before ‘end of shelf life’ conditions converge into a range of optimal OTR, referred to herein as the convergence point. The convergence point is the top of the curve(s) in FIG. 1. The present embodiment creates a package where these two conditions converge, as described herein.

In the low OTR end of the spectrum, anaerobic conditions occur progressively as they build up CO₂ concentrations and lower O₂ levels. These conditions hinder the produce's ability to carry out aerobic respiration and create an environment that favors anaerobic microbiological growth.

In the high OTR end of the spectrum, Aerobic respiration generates high levels of moisture and creates an environment favorable to mold growth and consume the produce's energy reserves. Moisture accumulates more slowly in progressively lower OTR packages but eventually reaches the level where mold will occur.

The optimum OTR level is determined by the last package to reach either of these conditions, anaerobic conditions or mold growth, for any given size. This is referred to herein as the convergence point.

FIG. 1 illustrates a chart showing the Relationship between the OTR and the shelf life of the product. The left side of the chart, where the OTR is small e.g. less than 500 mL per day per package per atmosphere shows small OTR leading to aerobic conditions. The y axis of this chart shows “shelf life”, which is the first time that mold can be seen on the product.

Too small OTR, as on the left side of the chart, e.g., less than 480 ml/day/package/atm, can produce a shelf life which is relatively small. The right side of the chart, where the OTR level is higher, shows significant amounts of air recirculation, leading to aerobic respiration. For example, this can also reduce the shelf life when the OTR for example in this chart is greater than 720-1500 mL per day per package per atmosphere. The ideal point, that is the point of convergence, is the peak of the curve. However, anywhere within 20% of the peak of the curve is considered ideal for purposes of this application. According to this embodiment, the package OTR is maintained between 480 and 720 ml/day/package/atm.

Note also, that different curves are shown in FIG. 1, with the lower curve being taken for produce in a package without any additional structure. The upper curve representing the same situation with the addition of the humidity controller as described herein as a second embodiment.

The curve in FIG. 1 shows in the bottom curve, a peak around 600 ml/day/package/atm. The ideal portion of this curve is +/−20%, so between 480 and 720. The top curve produces even longer shelf life, and can be used in a similar way.

As explained herein, optimum OTR can be based on a number of different parameters, including the product type, and the product weight. For a specific variety of produce, the relative OTR level of a package as set according to the present techniques is designed for a specified amount of weight of produce within the package. The OTR level is effective as optimal as long as it is kept in proportion to the weight of the produce. During our experiment it was determined that 300 g of blueberries sealed in a tray with four 100 um holes were found to be optimal. For a package containing 750 g of blueberries; ten 100 um perforations, six 150 um perforations or thirty 50 um perforations would provide the optimal OTR level. However, all different product sizes and product weights and package sizes can be handled in the same way using the techniques described above to create the graph of FIG. 1 showing the relationship between OTR level and shelf life, finding the peak of that graph, taking a point within 20% of that peak, and using those experimental results to create the package.

A few examples are provided herein: For 300 g of strawberries, four 100 um holes is optimum.

For 400 g of cucumbers two 100 um holes is optimum.

Holes are determined by size and number taking into account package's film's natural OTR in addition to the holes that are formed. Each packaging film has an OTR. Oxygen that diffuses though the film contributes to the available oxygen within the package for respiration.

The OTR for non-perforated packages is first calculated. A number of perforations are adjusted downward to achieve the optimum level of OTR while taking into account the OTR of the non-perforated packaging film. For example a package made of film that has an OTR value of 150 cc/day/100 in2/atm and a surface area of 200 in2 would transmit 300 cc of oxygen per day per atmosphere without perforations. The number of perforations would have to be reduced by two 100 um perforations, one 150 um perforation or six 50 um perforations below the optimum discussed above, in order to compensate for the additional oxygen available through the package's film.

More generally, however, a number of perforations is selected which maintains, for a given package size, volume and contents, a balance between aerobic conditions and anaerobic conditions.

According to the present application, the location of the holes is also important. Holes should be placed where they are least likely to be blocked by stacking packages or where the produce will press against them and block them. For example, in one embodiment, the holes can be placed in the top of the package at locations where they will still receive air even when stacked with other packages.

FIG. 2B illustrates this embodiment showing a package 200 in cross section along the line A-A, stacked on top of another package 250. In this embodiment, the bottom of each package includes indentations where the top package 250 includes indentations such as 251 located in or near areas where the perforations 210, 211 will be located in the bottom package.

According to another embodiment, the package bottom can be slightly domed with a high point in its center so that the top package 260 sits on top of the bottom package but touches only at the tangent point between the domed package and the top part with recesses in the tangent point 265 to allow air to be exchanged with in the domed area. This has the effect of allowing air flow into the packaging, even when the packages are stacked. This embodiment is shown in FIG. 2D.

Temperature of the package can also be critical for determining the shelf life of the product. In an embodiment, the storage temperature of the package and produce is preferably maintained at the recommended level for that particular variety of produce in the testing described above to find the optimum OTR level that can be carried out at the recommended temperature. The respiration rate of the produce is affected by the temperature and is generally increased at a higher temperature within a range that does not damage the produce's viability. An OTR level design for refrigerated conditions has been found by the inventor to be less effective for temperature outside of that range for long periods of time. The ability of the produce to re-establish optimal oxygen levels once reintroduced to the designed for temperature is possible depending on the length and extreme of deviation, typically acceptable is several days at room temperature before returning to refrigerated temperatures.

Moisture or humidity control within the package is also used according to an embodiment. The use of moisture or humidity control can increase the shelf life of a product. Therefore, there will be a completely different curve set for the humidity controlled package.

In one embodiment, a moisture control device 230 with moisture driven automatic opening valve is used inside the package. This moisture control device can be, for example, the device described in our co-pending application Ser. No. 15/359,373, filed Nov. 22, 2016 the entire contents of which are herewith incorporated by reference. This moisture control device for example can use a satchel of desiccant, covered with a valve that is automatically opened and closed by the amount of humidity in the package. Excess moisture can open the valve, causing the moisture in the package to be absorbed by the desiccant. When the humidity goes below the valve set level, the valve is again closed. This can have the effect of controlling the humidity inside the package.

A moisture control device can have the effect of extending the optimal OTR level into the higher end of the spectrum. As the limiting factor of mold growth is pushed back from the convergence point of what was optimal, the number of days before the convergence point is reached is extended. This extension of the convergence point translates into extended shelf life.

In an alternative embodiment, the moisture control valve 230 can be located between the inside and outside of the package, and automatically opened by high humidity in the package to automatically vent the package. This allows regulated desiccant absorption so that the rate of moisture generated by respiration is regulated by the OTR level of the package.

The desiccant pack that is designed to absorb generated moisture near this known rate to maintain a level of humidity that limits condensation and mold growth. The rate of moisture absorption is designed by the packet that holds the desiccant. The packet's film is made of a film with a known Water Vapor Transmission Rate (WVTR). Given the area of the film forming the packet and the WVTR of that film, the desiccant packet operates to absorb the proper amount of humidity. Too much absorption dehydrates the produce and causes the desiccant to become saturated prematurely. Too little absorption and the higher humidity would lead to condensation and mold growth. Hence, the vented dessicant package can be an additional way of maintaining shelf life of the produce.

Another way of reducing humidity is by using High water vapor transmitting film as the film cover 205. A film such as Nylon or Cellulose has a high water vapor transmission rate that allows excess humidity to transpire and lower the internal package's humidity level. The perforation pattern may be changed if using this type of film.

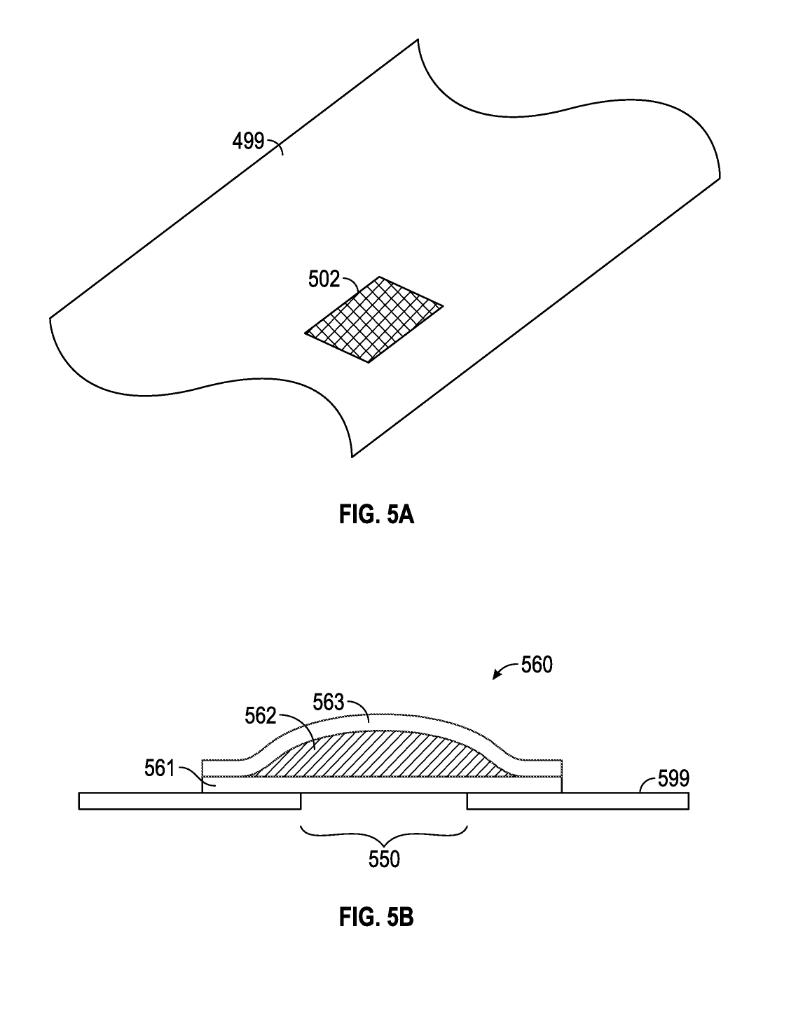

Another way of reducing humidity is by using an Enhanced water vapor transmitting film 499 as shown in FIG. 5A. A patch of hydroscopic salt 502 such as Calcium Chloride (CaCl2) is located on the exterior the film 499. The salt draws water though the film to the exterior of the package. As water accumulates on the film's exterior surface, some of that water evaporates. The process of evaporating water from this patch of salt cools the area. The cooling lowers the temperature below that of the rest of the package and determines the location of any available condensation. The condensation on the inside of the package film is drawn though the film and perpetuates the cycle. This cycle lowers the internal humidity and redirects any condensation away from the produce.

Another embodiment of FIG. 5B forms an opening 550 in the package film 599 (which in this case does not have to be a high water vapor transmitting film), and forms a patch 560 covering that opening. The patch 560 can be a PSA Tyvek label with a gelled CaCl₂ solution 562 in the center. The gelled CaCl₂, is sandwiched between the high water vapor transmitting film 561 and the Tyvek 563 or any combination of the two. In operation, the water vapor can pass through the water vapor transmitting film 561, through to the gelled CaCl₂, where it is absorbed by the CaCl₂, to reduce the humidity. Another issue is that the need for oxygen by a given produce is not constant. The duration that a variety of produce can endure anaerobic conditions is determinable. After a determinable time, cellular death of the produce can occur. If the produce is exposed to higher levels of oxygen before the time of cellular death, the produce can clear the negative effects of the low oxygen and reset the clock.

Likewise, anaerobic microbiological growth is killed off when exposed to higher levels of oxygen. Given that these two conditions are met, the produce would be ready to endure another brief, timed exposure to anaerobic conditions. The number of times that a variety of produce can endure this cycle of aerobic/anaerobic conditions can be determined through trial. The amount of sugar or energy burned though respiration is much lower than even the best OTR burn rate. This would also reduce the amount of moisture produced by respiration. The extension of shelf life and quality of the produce could be greatly increased. Two different embodiments of exposing the produce to higher levels of oxygen, in order to extend the time until cellular death, are disclosed herein.

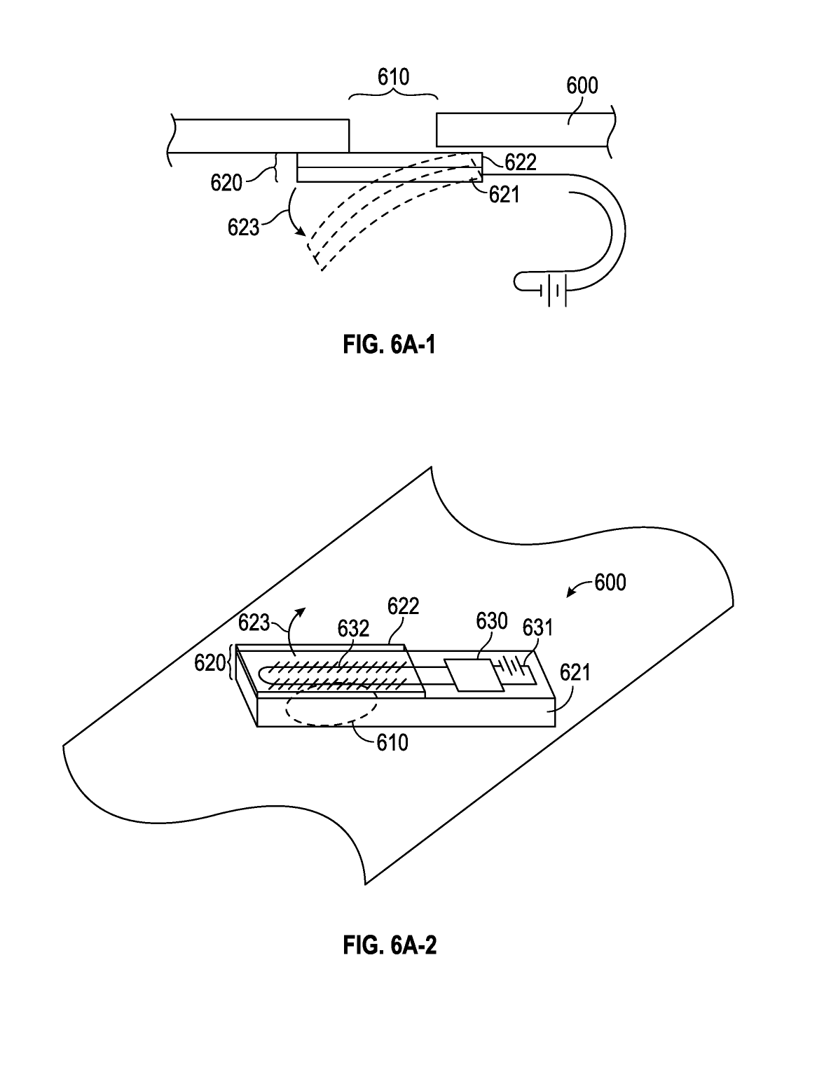

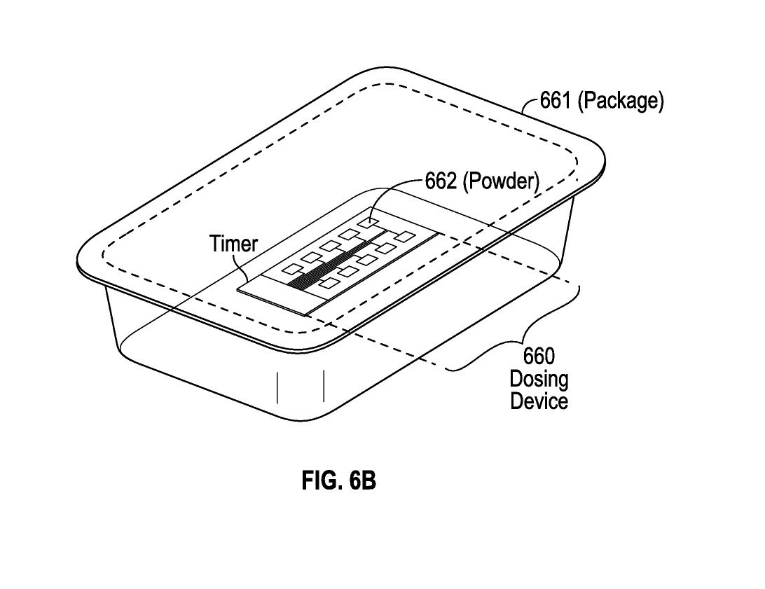

A valve that opens at timed intervals can be used, as shown in FIGS. 6a1 and 6a2. In the FIG. 6a1 embodiment, the package film 600 includes an opening 610 on which a stacked valve 620 is located. The valve is formed of a stack of nylon 621 and PET 622. The nylon 621 swells with higher humidity, while the PET 622 does not so swell, causing the valve to change shape with humidity change. Other materials can be used in place of the nylon or PET, although nylon has an advantage of swelling. The stack formed of the nylon/PET therefore curves along an axis as shown by the arrows 623 when the humidity in the package becomes higher than the set amount. When the humidity becomes lower, the valve remains closed. In one embodiment shown in FIG. 6a2, a circuit 630 is controlled by a battery 631 and produces heat at timed parts during the cycle. Each time the heat is produced, the valve is caused to open until the heat is removed. By pulsing this heat source on and off, the valve can be periodically opened and closed.

An other humidity swelling, similar to the valve disclosed in Our Provisional application number 62331372 can be controlled though a printed circuit 630 that generates heat in a Nylon laminate by the resistance in the circuit portion 632. The heat dries the nylon thus shrinking it, which in turn “pulls” a flap open.

Another embodiment shown in FIG. 6B can use a dosing device 660 of an oxygen generating powder 662 inside the package 661. The device is periodically activated using a timer. In one embodiment, the powder can be of the type used to oxygenate water while transporting fish. The device 660 is then configured to dose the package with a given amount of oxygen from the powder 662 at prescribed intervals.

Opportunities to control humidity and extend shelf life are disclosed as an embodiment. An optimum package design can be carried out with the humidity reduction techniques.

Other embodiments are contemplated. For example, while the above embodiments have described specific materials, other materials could be included.

Those of skill would further appreciate that these features can be carried out using different materials and different techniques and different shapes.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of forming a package holding perishable produce, comprising:
determining, for a first package having a first size and shape and first contents, a relationship between a shelf life of said first contents in said package for different oxygen transfer rates expressed as volume of oxygen per time period per package per atmosphere;
finding an optimum oxygen transfer rate which maximizes shelf life, and finding a range around the optimum oxygen transfer rate;
selecting a number and size of laser micro perforations, of a size less than 150 um, to obtain the optimum oxygen transfer rate and creating a package in said first package with the number of laser micro perforations to have an oxygen transfer rate within the range, wherein the selecting comprises selecting a 100 μm diameter orifice as equated to an OTR of 150 cc/day/atmosphere and having a linear slope of 2 cc/day/atm per additional 1 um in diameter;
forming the first package with the number of laser micro perforations; and
forming a humidity reduction device in the package prior to said determining, and using the humidity reduction device to remove the humidity package.

2. The method as in claim 1, wherein the size of the laser micro perforations is selected by determining a size of the perforations as substantially linear within a range.

3. (canceled)

4. The method as in claim 2, further comprising determining the micro perforations by determining a size and number taking into account a natural oxygen transfer rate of the package in addition to the micro perforations, by first determining an oxygen transfer rate for a non-perforated package and a surface area of the package, determining the desired oxygen transfer rate, determining a number of perforations to obtain the desired oxygen transfer rate, adjusting downward the number of perforations to achieve the optimum level of oxygen transfer rate and to compensate for the additional oxygen available through the package's film.

5. (canceled)

6. The method as in claim 5, wherein said humidity reduction device comprises a sachet of desiccant, and further comprising selectively exposing desiccant in the package to the inside of the package when the humidity gets higher than a level, and isolating the desiccant from the inside of the package when the humidity gets lower than the level.

7. The method as in claim 5, wherein the humidity reduction device includes a vapor transmitting film in the package with a high water vapor transmission rate that allows excess humidity to transpire and lower the internal package's humidity level.

8. The method as in claim 7, wherein the vapor transmitting film is one of nylon or cellulose that is processed to have the high water vapor transmission rate.

9. The method as in claim 7, wherein the vapor transmitting film includes a hydroscopic salt on an exterior of the film which draws condensation through the film to the exterior of the package.

10. The method as in claim 9, wherein the hydroscopic salt includes a calcium chloride salt.

11. The method as in claim 7, further comprising locating the vapor transmitting film over a hole in the package film, and locating a gelled material over the vapor transmitting film.

12. The method as in claim 1, further comprising finding intervals of time less than an amount which would cause cellular death in package contents, and pulsing air delivery to the inside of the package, at intervals of time less than the intervals which would cause cellular death.

13. The method as in claim 11, wherein said pulsing comprises using a valve that opens at intervals to provide air to the inside of the package when opened.

14. A package for holding a perishable produce, comprising:
A package body, formed of a package film having a first size and shape, formed with laser micro perforations formed according to a relationship between a shelf life of said first contents in said package for different oxygen transfer rates expressed as volume of oxygen per time period per package per atmosphere which optimizes between anaerobic conditions and aerobic conditions, having a number and size of micro perforations, of a size less than 150 μm, to obtain an optimum oxygen transfer rate and creating a package in said first package with the number of micro perforations to have an oxygen transfer rate within the range; and a humidity reduction device in the package prior to said determining, and the humidity reduction device to remove the humidity from the package.

15. The package as in claim 14, wherein the micro perforations are formed in a location of the package which retains airflow through the micro perforations when multiple of said packages are stacked.

16. The package as in claim 14, wherein the micro perforations have a size between 50 and 150 μm.

17. (canceled)

18. The package as in claim 17, wherein said humidity reduction mechanism includes a humidity controlled valve which opens when the humidity gets higher than a level to reduce humidity, and closes when the humidity gets lower than the level.

19. The package as in claim 17, wherein the humidity reduction includes a vapor transmitting film with a high water vapor transmission rate that allows excess humidity to transpire and lower the internal package's humidity level.

20. The package as in claim 19, wherein the film includes a hydroscopic salt on the exterior of the film which draws condensation through the film to the exterior of the package.

21. The package as in claim 20, wherein the hydroscopic salt includes a calcium chloride salt.

22. The package as in claim 19, wherein the vapor transmitting film is located over a hole in the package film, and has a gelled material over the vapor transmitting film.

23. The package as in claim 14, further comprising a valve that is opened at intervals to pulse air delivery to the inside of the package, at intervals of time less than intervals which would cause cellular death.
